(19) United States
(12) Patent Application Publication
(10) Pub. No.: US 2026/0273851 A1
(43) Pub. Date: Sep. 17, 2026

(54) Modular Dual Fusion Modeling 3D Printing Apparatus and Methods

(71) Applicant: Aveniya Inc., Foothill Ranch, CA (US)

(72) Inventors: Krishnamohan Sharma, Milpitas, CA (US); Dax John Hamilton, Scio, OR (US); Venkata S. Sarva, Fremont, CA (US)

(21) Appl. No.: 19/078,266

(22) Filed: Mar. 12, 2025

(51) Int. Cl. B29C 64/295; B29C 64/118; B29C 64/209; B29C 64/268; B29C 64/393; B33Y 10/00; B33Y 30/00; B33Y 50/02

(52) U.S. Cl. CPC B29C 64/295; B29C 64/118; B29C 64/209; B29C 64/268; B29C 64/393; B33Y 10/00; B33Y 30/00; B33Y 50/02

(57) ABSTRACT

A 3D printing apparatus featuring Dual Fusion Modeling (DFM) technology, which combines an extrusion system that fuses melted layers along with a precise local heating system that reinforces fusing between printed layers to obtain 3D printed objects with superior properties. This apparatus excels in fabricating various objects from 3D printed polymers to plastics to ceramics to metallics to composites by employing a precise laser or thermal energy targeted at extruded materials. The laser can be adjusted for material-specific needs, ensuring optimal fusion, or vaporization of organics, or cutting extruded layers at targeted locations. An intelligent control system synchronizes the extrusion system and the localized heating system for efficient fusion (or separation) of printed 3D objects, with a feedback loop that fine-tunes laser energy or related parameters for continual ideal fusion conditions. final

### BACKGROUND OF THE INVENTION

The evolution of 3D printing has been marked by continual improvements in material versatility, object resolution, and fabrication speed. Traditional methods such as Fused Deposition Modeling (FDM) and selective laser sintering (SLS) have fostered substantial advancements in the field of additive manufacturing. However, limitations persist in terms of the heterogeneity of material layers, resolution, the mechanical strength/integrity of finished products, surface finish, elasticity, optical clarity, ease of separating 3D printed objects from the support structure, and the complexity of the objects that can be reliably fabricated. The burgeoning demand for the integration of different material types within a single print job, particularly those incorporating metallic or ceramic components, has driven the innovation of new techniques capable of overcoming these constraints. Simultaneous extrusion and targeted laser fusion represent a convergence of technologies aimed at surmounting the extant challenges, exploiting the benefits of both thermal extrusion and localized heating of 3D printed parts to dramatically improve and versatility and quality of the 3D printed objects for medical and precise engineering applications. This holistic approach to 3D printing promises to enhance material deposition with precise laser fusion, ensuring uniformity and bonding strength that lends itself to a diversity of advanced applications ranging from biomedical engineering to complex mechanical assemblies.

### SUMMARY OF THE INVENTION

In one aspect, one implementation is an apparatus for 3D printing that utilizes Dual Fusion Modeling (DFM) technology. This apparatus features an extrusion system designed to lay down successive material layers on a build platform that intrinsically fuse in melt phase and an additional directed energy system or localized heating source, dedicated to providing targeted heating to these layers, fostering uniform fusion and enhancing the material characteristics. Additionally, a control system is integrated to synchronize the extrusion and local heating systems, ensuring the extruded material solidifies concurrently. The extrusion system could include any polymeric material or composite material (filaments) made of polymers or organic binders comprising metal particles or ceramic particles. The polymeric materials could be optically transparent or colored. Further, any of these filaments could be doped with light or laser (250 nm to 2500 nm) absorbing organic or inorganic dyes that promote efficient energy absorption radiation energy for DFM printing. The extrusion system can also include the heater and filament guide and filaments in other embodiments.

In another aspect, a method of 3D printing using Dual Fusion Modeling (DFM) technology includes extruding a filament comprising a polymeric material or a composite material ; depositing the extruded filament in a predetermined pattern; simultaneously applying localized heat or laser energy to the deposited filament; and controlling the extrusion and localized heating parameters to achieve homogeneous fusion of the deposited filament and separation of support structure.

In yet another aspect, a method of creating transparent 3D printed objects includes extruding a transparent filament material; applying precisely controlled laser energy to fuse the extruded material to preserve optical clarity.

In yet another aspect, a method of 3D printing a device includes selecting a biocompatible polymeric or composite filament; extruding and depositing the filament in a predetermined pattern; applying laser energy to fuse the deposited filament; and controlling the laser energy to maintain desirable biosafety and biomechanical properties.

In yet another aspect, a method of 3D printing dental devices includes selecting a biocompatible polymeric filament; extruding and depositing the filament in a predetermined pattern; applying laser energy to fuse the deposited filament; and controlling the laser energy to maintain material properties suitable for dental applications.

In yet another aspect, a method of creating microfluidic devices using DFM technology includes extruding a filament material suitable for microfluidic applications; depositing the filament to form channel structures; and applying controlled laser energy to precisely fuse the deposited filament while maintaining channel integrity.

In a further aspect, a method of 3D printing using Dual Fusion Modeling (DFM) technology includes extruding a filament comprising a polymeric material or a composite material; depositing the extruded filament in a predetermined pattern to generate a 3D object; applying laser energy to said 3D printed object in a predetermined pattern; and optimizing the optical, and mechanical properties of said 3D printed object, and an ease of separation from the support structure.

Implementations of the above aspect can include one or more of the following. The laser parameters include at least one of wavelength, intensity, power, spot size, duration and pulse rate. The method includes utilizing a feedback loop or software controls to continuously monitor and adjust laser energy for optimal fusion conditions. The method includes utilizing a feedback loop or software controls to continuously monitor and adjust laser energy for weakening inter and intra layer bonds for an easy separation of support structure from the 3D object. The 3D printed objects are retainers, aligners, teeth whitening trays, mouthguards, dental implant guides, sleep apnea devices, and dental shells for drug delivery.

Other aspects of the invention are detailed in the claims. Advantages of one implementation may include one or more of the following:

Enhanced Material Properties: One implementation aims to improve the mechanical strength, thermal stability, and electrical conductivity through the precise application of laser energy, enabling better fusion between heterogeneous materials such as composite filaments with embedded metal or ceramic particles.

Increased Resolution and Precision: The targeted localized heating system or laser localized heating or laser can heat specific zones of the material in a controlled manner, improving the resolution, light transmittance, optical clarity, and precision of the 3D printed object and allowing for the creation of complex geometries with finer details.

Greater Structural Integrity: By ensuring a uniform fusion of the printed layers, one implementation can produce objects with superior structural integrity compared to those made with traditional 3D printing methods, reducing the occurrence of weak points and stress concentrations.

Versatility: The apparatus is capable of processing a wide range of polymeric materials, including advanced composite filaments, thus broadening the spectrum of applications for which the 3D printer can be utilized. Composite in one case could be a polymer and ceramic particles, polymer and metal particles, or different polymer types, among others

Multimaterial Capability: One implementation enables the integration of different material types within a single print job, which can be particularly beneficial for functional gradations and composite structures requiring distinct mechanical or physical properties at different sections of the objects.

Speed and Efficiency: By combining the extrusion and laser sintering processes into one cohesive system, the overall fabrication time may be reduced, leading to more efficient production runs.

Cost-Effectiveness: The ability to create high-quality parts with enhanced material properties may decrease the need for post-processing procedures, reducing the overall cost of manufacturing.

Scalability: The design of the apparatus allows for modifications to scale the size of the build area and adapt different laser power levels for larger or more demanding print tasks.

Improved Thermal Management: The targeted application of laser energy can be optimized for each material type, reducing the risk of warping and other defects that arise from uneven cooling and thermal stresses.

Simplified Workflow: The control system streamlines the 3D printing process by automating the coordination between extrusion and laser sintering, reducing the complexity of the workflow and the potential for user error.

Energy Efficiency: The focused use of laser energy only where it is needed can lead to reduced energy consumption as compared to methods which require heating the entire build platform or a large area around the print job.

Post Processing: The 3D printed object could be easily separated into different parts or from support system or platform either using or not using laser energy to create weak or strong bonds at targeted areas to easily separate desirable 3D printed object from the support structure with minimal or no post processing work.

Printing Metals: Extruding filaments composed of organic binder and metal particles could be extruded and printed while using laser energy to vaporize organic component to fuse metal particles together into 3D metal objects

Printing Ceramics: Extruding filaments composed of organic binder and ceramic particles could be extruded and printed while using laser energy to vaporize organic component to fuse ceramic particles together into 3D ceramic objects.

Print Composites: Extruded filaments composed of organic. Component and non-organic component could be fused together with right amount of laser energy in such a way that composite 3D objects are made with targeted properties.

The Dual Fusion Modeling (DFM) technology system proposed here enables precise control over fusion between extruded layers printed in a pre-determined pattern and allows the separation or detachment of selective layers within the 3D object (i.e., promotes intra layer or inter layer bonding for fusion or weakens it for detaching supporting structure) using combination of software and laser energy related parameters. The localized heat system and software controls may also be configured to create intra-or inter-layer separation of 3D printed object by altering bonding strengths within the layer and/or in between extruded layers. The filament used for printing purposes could be any polymeric, or composite filament comprising both organic and inorganic particles (metallic, ceramic, or inorganics). At least one or combination of localized heating systems (e.g., lasers), facilitate the fabrication of 3D objects printed with relatively high mechanical strength and/or optical clarity and biomechanical properties useful for various life sciences and medical applications. The DFM system software and hardware controls makes it easy to remove support structure by selectively manipulating the bonding strength within and in between the layers.

The DFM systems utilizes polymeric resins or composite filaments (incorporating metal, ceramic, or inorganic particles along with a binder) with diameters ranging from 0.05 mm to 10.0 mm. Additionally, these filaments may contain light-or laser-absorbing dyes of specific wavelengths, either integrated within the filament or applied as an overcoat to optimize the laser material interactions for fusing or cutting the filaments. A localized heating spot size range could be anywhere from 1-10,000 microns, however, an optimal range could be in 50 to 1,000 microns. The extruded object may be exposed to predetermined heating period ranging from 1-60 seconds, preferably less than 20 seconds, and most preferably under 1 second.

A localized heating system/laser track may precede or follow the extrusion track, allowing the fusion of multiple layers simultaneously. Alternately, the localized heating system or laser could be applied to the 3D object, post printing, to ensure desired material properties are achieved (e.g., optical, mechanical, support structure separation, surface finish etc.). The DFM build platform may be equipped with an automated system for the removal of 3D printed parts, improving efficiency and workflow. Additionally, a control system with a sensor and feedback loop is integrated to optimize thermal energy management, ensuring proper fusion and separation.

To fabricate metal or ceramic objects, the localized heating system selectively targets specific regions of extruded layers, vaporizing organic substances, if needed, while fusing metal or ceramic particles. The extrusion system can implement a temperature gradient between layers to modify structural integrity and bonding strength. The extruder nozzle of DFM system features variable nozzle shapes, including circular, elliptical, square, rectangular, and hexagonal designs.

Methods of 3D printing using DFM may also involve extruding composite filaments containing metal or ceramic particles while simultaneously applying laser energy to fuse the material. The system controls the laser energy to ensure homogeneous fusion, achieving precise structural characteristics. Printed objects may be formed on a plastic sheet covering the build platform, with a transport mechanism for part removal. A removable substrate, advanced by a roller mechanism, aids in efficiently transporting printed objects out of the printing chamber.

Synchronization of filament extrusion and laser energy application ensures simultaneous deposition, fusion, and solidification. The temperature gradient technique further enhances interlayer bonding, improving the mechanical properties of the printed object. Selective laser application allows for differential fusion, enabling easy removal of support structures.

Raw materials such as resin beads, pellets, and powders can be directly fed into the extruder head, streamlining material handling. Laser energy parameters are dynamically adjusted based on filament material properties.

The invention also supports secondary material incorporation during printing through a separate extrusion nozzle. Two or more localized heat sources or lasers may be employed—one for fusion and another for cutting—enhancing object properties and facilitating support removal. Post-processing using laser energy can selectively modify material properties or surface characteristics, further expanding the capabilities of DFM technology. The disclosed apparatus and method provide a highly versatile and efficient approach to 3D printing, enabling the production of high-strength, optically transparent customizable objects with controlled material properties and simplified post-processing. Overall, this 3D printing apparatus represents a significant step forward in addressing the limitations of existing additive manufacturing technologies, especially with regard to printing medical appliances, microfluidic devices, and dental shells such as retainers, aligners, mouth guards, teeth whitening trays, dental implant guides, sleep apnea devices, and the like offering a platform for the production of complex, multi-material, and high-performance objects suitable for a variety of cutting-edge industrial, commercial, and research applications using a modular dual fusion modeling printing platform.

### BRIEF DESCRIPTION OF DRAWINGS

FIG. 1A shows diagram illustrating a conventional extrusion of plastic sheets with homogeneous polymeric structure.

FIG. 1B shows cross-section view of a 3D printing process showing filament extrusion, layer temperatures, and non-homogeneous polymer structure.

FIG. 1C shows dual. fusion, where nozzle extruding melt layer on top of a receiving layer is additionally fused together cohesively with a localized heating system or laser or laser resulting in a homogenous polymeric structure illustration

FIG. 1D shows dual fusion 3D printing process illustrating composite filament extrusion with laser sintering forming metal or ceramic objects while vaporizing organic components.

FIG. 2 shows an exemplary laser fusion of layers (a) and layers with an overcoat. The laser profile is matched to targeted fusion region.

FIG. 3 shows feed hopper with resin beads connected to extruder head producing filament and subsequently a 3D printed object.

FIG. 4 shows an exemplary nozzle and rollers extruding filament onto a platform forming 3D object and transferring the printed object.

FIG. 5 shows an exemplary table with fusion temperature and bond strength comments for plastic coupons.

FIG. 6 shows differences between conventional printed parts and double fusion parts formed according to the present system.

FIG. 7 shows graph comparing stress-strain properties of single fusion and double fusion 3D printed plastic sheets.

FIG. 8 shows schematic of a 3D printing process using a laser for localized heating and extrusion preceding or following extrusion system.

FIG. 9 shows application of laser energy post 3D printing.

FIG. 10A shows an illustration showing layer structures with labels indicating strong and weak bonds and a process of separation post-3D printing easily.

FIG. 10B shows exemplary software control to form the part of FIG. 10A to produce high performing 3D objects and easy post processing steps.

FIG. 11 shows an illustration of an exemplary dual fusion header system.

FIG. 12 shows an exemplary nozzle and filament assembly with laser beam, heating element, and beam guide mirror in 3D printer extrusion head design.

FIG. 13 shows nozzle design for 3D printer head incorporating laser beam and optical elements with annotations.

FIG. 14 shows exemplary modular design renderings and schematic of a DFM 3D printer with customizable components for various applications.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Without being bound by theory or hypothesis, the present invention is described in view of certain principles, which are provided for illustrative purposes only and should not be interpreted as limiting the scope of the claims. Furthermore, reference to various feature(s) of the “present invention” throughout this document does not mean that all claimed embodiments or methods must include the referenced feature(s).

A 3D printing device featuring Dual Fusion Modeling (DFM) technology combines an extrusion system with a precise local heating system or laser. Although extruded layers adhere with each other in melt phase, the time and temperature gradients during FDM printing process limit the quality of fusion between the printers layers. Therefore, by supplying localized energy from an additional heating source (e.g., laser), the layers can be re-fused forming high quality 3D printed objects that may exceed the quality of conventional injection molded or thermoformed or extruded printing parts (e.g., thickness of thermoformed materials are not uniform across for precise applications). The overall advantages of DFM printing technology are:
Improved Print Speed: The integration of localized energy sources, such as lasers, allows for faster printing speeds by enhancing the layer-by-layer deposition process.
Enhanced Resolution: The ability to control the energy application precisely results in higher resolution prints, overcoming the traditional limitations of FDM technology.
Increased Mechanical Strength: The use of localized energy sources promotes better inter-layer bonding, resulting in printed objects with higher mechanical strength suitable for high-stress applications.
Superior Surface Finish: The precise application of energy smooths out surface irregularities, leading to a finer surface finish on the printed objects.
Optical Transparency: The enhanced fusion of layers facilitated by the energy source improves the optical transparency of the printed objects, making them suitable for applications requiring clear materials.
Reduced Post-Processing: The creation of weak bonds in support structures allows for easy removal without extensive post-processing, streamlining the overall workflow.
Versatility in Material Use: The modular DFM technology supports the use of various thermoplastic materials, or filaments or beads containing metal or ceramic particles offering versatility in types of objected printed from a single platform.
Cost-Effectiveness: FDM remains a cost-effective solution compared to other 3D printing technologies, making it accessible for a wide range of applications.
Biosafety: The use of extruded polymers, which do not require volatile organic solvents, ensures a safer printing environment.
User-Friendly: The system is designed to be easy to use, requiring minimal setup and maintenance, which is beneficial for rapid prototyping and production.
Smaller Footprint: FDM printers typically require less space, making them suitable for various operational settings.
Integration of Multiple Materials: The technology allows for the integration of more than one material type or color within a single printed object, enhancing design flexibility.
In Situ Monitoring and Quality Control: The integration with sensors and machine learning algorithms enables real-time monitoring and quality control, ensuring consistent part quality.
Less Chemical Waste: The dry printing conditions of FDM reduce the need for chemical handling and waste management, making it an environmentally friendly option.
Enhanced Customization: The technology supports the production of highly customized medical devices, medical implants and dental devices.
Improved Safety: The absence of volatile organic compounds in the printing process enhances the safety of the working environment.
Simplified Support Removal: The ability to create weak bonds in support structures facilitates their easy removal, reducing the time and effort required for post-processing.
Optimized Software Algorithms: Advanced slicing software coordinates the extrusion and energy application processes, optimizing print parameters for better results.

This device excels in fabricating items with complex material properties by layering filaments made with various polymers (e.g., PLA, ABS, PET, PETG, TPU, Nylon, PC, HIPS, PVA, ASA, PP, PC-ABS) or their combinations or composite filaments that are infused with metal particles (e.g., Stainless Steel, Titanium, Aluminum, Copper, Gold, Silver, Platinum, Palladium, Zirconium, Tantalum, Molybdenum, Nickel, Inconel, Cobalt-Chrome, Tungsten) or ceramic particles (e.g., Aluminum Oxide, Aluminum hydroxides, Zirconium hydroxide, Zirconium Oxide, Silicon Oxide, Silicon Hydroxide, Silicon Carbide, Silicon Nitride, Hydroxyapatite, Tricalcium Phosphate, Cordierite, Steatite, Mullite, Spinel, Glass Ceramics, Boron Carbide, Boron Nitride, Graphite, Gypsum) in an organic binder and employing a precise laser for homogenous material fusion. Uniquely, it can use polymeric or composite resin beads directly, avoiding the need for pre-made filaments, expanding material choices and increasing feed efficiency. Any of the above mentioned polymers or composites can be additionally infused with laser or light absorbing dyes in 200-2500 nms region. Some of the light absorbing dyes include: Carbon Black, Titanium Dioxide, Irong Oxide, Phthalocyanine Blue: Phthalocyanine Green, Quinacridone, Azo Dyes, Fluorescent Dyes, and near IR absorbing dyes (Clearweld®: A common IR-absorbing dye, ideal for clear plastic laser welding, IRGAPACK® IR: Specialty NIR, Perylene Black, Ciba TINOSORB®) . The laser can be adjusted for material-specific needs, ensuring optimal fusion, while an intelligent control system synchronizes extrusion and laser actions for simultaneous material solidification, with a feedback loop that fine-tunes laser energy for continual ideal fusion conditions. An innovative feature of the build platform involves an automatic removal mechanism with a roller-fed plastic sheet to ease the detachment and transportation of completed items. The extrusion system's temperature gradient technique during deposition also improves the bond between layers and the final product's structural strength or system can also create weak bonds to easily separate supports from the desired 3D Object. This versatile machine can create objects with high resolution, transparency, strength, speed, biosafety, and material variety, and has extensive potential for creating medical devices, microfluidic systems, and various tools, poised to transform manufacturing in numerous industries.

The dual fusion modeling (DFM) technology addresses transparency limitations in conventional FDM printing by utilizing laser fusion. This process improves the optical clarity of the printed materials, ensuring higher transparency in the resulting 3D printed objects. Through double fusion, printed sheets exhibit excellent optical properties, making them suitable for applications requiring clear, transparent materials.

The DFM works with biosafe polymeric materials, ensuring that the materials and processes used do not pose health risks to users. It incorporates features that prevent the release of harmful emissions or particulates, thereby providing a safer working environment.

The 3D printing process is controlled by intuitive software and automated mechanisms, reducing the need for extensive user intervention. This advancement ensures a smoother workflow and enhances accessibility for users of varying skill levels.

The DFM 3D printer can work with a broad range of materials. This flexibility enables the printer to accommodate different types of filaments, to print metals, plastics, and ceramics, making it suitable for diverse applications such as medical devices, prototypes, and complex structures for various industrial applications. The DFM printer's adaptability enhances its functionality and usability across various industries.

One implementation addresses support removal by designing a 3D printer that allows for easy separation of support structures. This is facilitated by using dual fusion technology, which enhances bonding precision and minimizes post-processing. The process simplifies the removal of 3D printed parts or supports from printed objects, making the operation more efficient and user-friendly.

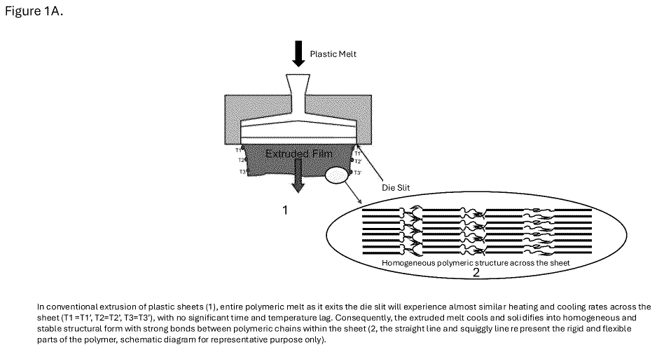

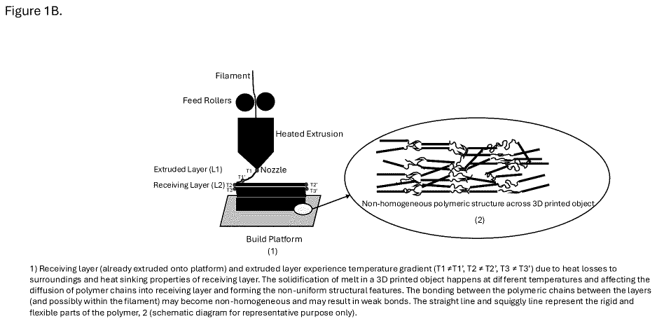

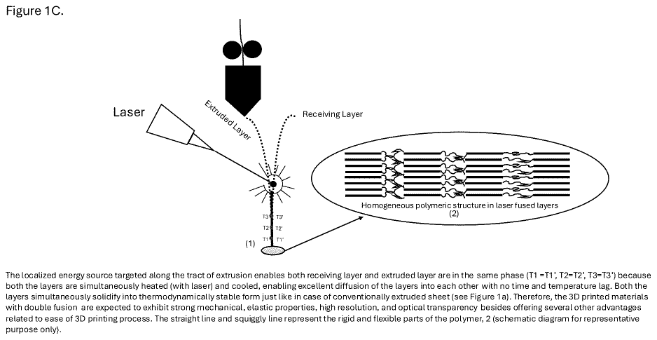

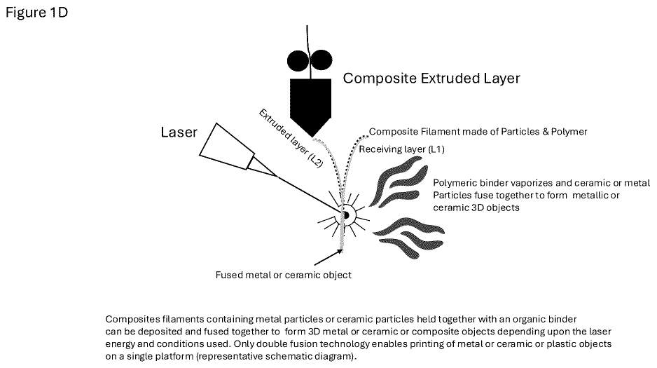

FIG. 1A illustrates a diagram of a conventional extrusion process for plastic sheets, highlighting a homogeneous polymeric structure throughout the sheet. The process involves the polymeric melt exiting the die slit and experiencing uniform heating and cooling rates across the sheet, resulting in a stable structure with strong polymeric chain bonds. In conventional extrusion of plastic sheets (1), entire polymeric melt as it exits the die slit will experience similar heating and cooling rates across the sheet (T1=T1′, T2=T2′, T3=T3′), with no significant time and temperature lag. The temperatures T1-T3 are hypothesized to explain why DFM provides superior fusion between the layers. Consequently, the extruded melt cools and solidifies into homogeneous and stable structural form with strong bonds between polymeric chains within the sheet (2, the straight line and squiggly line represent the rigid and flexible parts of the polymer).

The extruded film 1 is a layer made from polymeric melt exiting the die slit during the extrusion process. This layer undergoes uniform heating and cooling, ensuring consistent thermal conditions throughout. As a result, it solidifies into a stable and homogeneous structure with strong bonds between the polymeric chains. Here the term homogeneous is used to refer strong fusion between different layers as opposed a homogenous structure at molecular level like in a crystalline form. In FIG. 1A, the homogeneous polymeric structure, labeled as reference sign 2, illustrates the uniform arrangement of polymer chains across the extruded film. This structure is formed as the polymeric melt cools and solidifies, leading to consistent structural bonds throughout the sheet. The diagram shows the alignment of the chains, contributing to the creation of a stable and uniform material property across the entire sheet. The homogeneous polymeric structure 2 is a monolithic entity formed by the meticulously controlled solidification of the extruded material, orchestrated via the synchronized operations of the extrusion and localized heating system or laser or lasers. This structure exhibits improved mechanical robustness, elevated thermal endurance, and superior electrical conductance, attributes that are critical for the utility and functionality of the final printed objects. Through one implementation's technology application, the homogeneous polymeric structure ensures the structural integrity and detail preservation of the most demanding 3D printing tasks.

FIG. 1B shows a schematic depiction of an extrusion process resulting in non-homogeneous polymeric structure across a 3D printed object. FIG. 1B illustrates the filament extrusion, layer temperatures, and non-homogeneous polymeric structure across the printed object. The receiving and extruded layers are subjected to a temperature gradient due to heat loss and heat-sinking properties. This affects the diffusion of polymer chains into adjacent layers, potentially leading to non-uniform structures and weak bonds. The image includes a depiction of both rigid and flexible parts of the polymer that are not thermodynamically preferred.

The receiving layer, labeled as 1, is where previously extruded material is deposited onto the build platform. This layer experiences a temperature gradient due to heat losses to its surroundings. As the extrusion process continues, the new material is laid on top, influencing the diffusion of polymer chains into the receiving layer. This results in a heterogeneous structure, contributing to variations in material properties across the 3D printed object.

In FIG. 1B, a receiving layer L2 (already extruded onto platform) and an extruded layer L1 experience temperature gradient (T1≠T1′, T2≠T2′, T3≠T3′) due to heat losses to surroundings and heat sinking properties of receiving layer. The solidification of melt in a 3D printed object happens at different temperatures and affecting the diffusion of polymer chains into receiving layer and forming the non-uniform structural features. The bonding between the polymeric chains between the layers (and possibly within the filament) may become non-homogeneous and may result in weak bonds. The straight line and squiggly line represent the rigid and flexible parts of the polymer.

FIG. 1C shows an exemplary Dual Fusion Modeling system that features a blend of an extrusion system and a targeted localized heating system or laser or laser. The extrusion system is adept at dispensing composite filaments, specifically those containing a polymers or mixture of polymer matrix and embedded particles of either metal or ceramic, onto a receiving layer. It deposits successive layers onto a build platform, creating the foundation for the object being printed. The localized energy source targeted along the tract of extrusion enables both receiving layer and extruded layer are in the same phase (T1=T1′, T2=T2′, T3=T3′) because both the layers are simultaneously heated (with laser) and cooled, enabling excellent diffusion of the layers into each other with no time and temperature lag. Both layers simultaneously solidify into thermodynamically stable form just like in case of conventionally extruded sheet (see FIG. 1A). Therefore, the 3D printed materials with double fusion are expected to exhibit strong mechanical, elastic properties, high resolution, and optical transparency besides offering several other advantages related to ease of 3D printing process. The straight line and squiggly line represent the rigid and flexible parts of the polymer 2.

The homogeneous polymeric structure, referenced as label 2 inf FIG. 1C, signifies a uniform distribution of polymer chains across the 3D printed object. This structure is essential for achieving consistent mechanical properties throughout the material. In the depicted process, the transition of the polymer chains into a homogeneous configuration is crucial for establishing strong interlayer bonds, enhancing the overall strength and stability of the printed piece. This characteristic is achieved through precise thermal management and targeted laser heating, which ensures even fusion of the polymeric materials, and optical transparency if transparent materials are used.

FIG. 1D illustrates a dual fusion 3D printing process, showing the extrusion of composite filament with particles and polymer, alongside laser sintering to form metal or ceramic objects. The DFM embodiment uses a nozzle and localized heating system or laser or laser heating the extruded layers, along with the homogeneous polymeric structure in the fused layers. Composites filaments containing metal particles or ceramic particles held together with an organic binder can be deposited and fused together to form 3D metal or ceramic or composite objects depending upon the laser. The laser energy can be tuned in such a way that the organic binder part of the filament is vaporized while ceramic or metal particles fuse into each other forming ceramic or metal 3D objects. Therefore, double fusion technology enables printing of even metal or ceramic objects besides plastic objects on a single platform.

In FIG. 1D, a composite filament made of particles and polymer receiving layer L1 is merged with an extruded layer L2 and heated by a laser providing localized energy. In the example of FIG. 1D, a localized energy source (the laser) targets the tract of extrusion, ensuring that both the receiving and extruded layers are in the same phase, vaporizing organic binder, which promotes effective diffusion and bonding between metal or ceramic particles during solidification. The laser applies targeted heating to “receiving layer 1,” facilitating uniform fusion with subsequent layers. This process also enhances the integration of the composite materials with right amount of laser energy (i.e., with no organic binder vaporization), improving the mechanical and thermal properties of the printed object. The result is a 3D printed material with strong mechanical, elastic properties, high resolution. and optical transparency (in case of ceramic objects or polymeric objects).

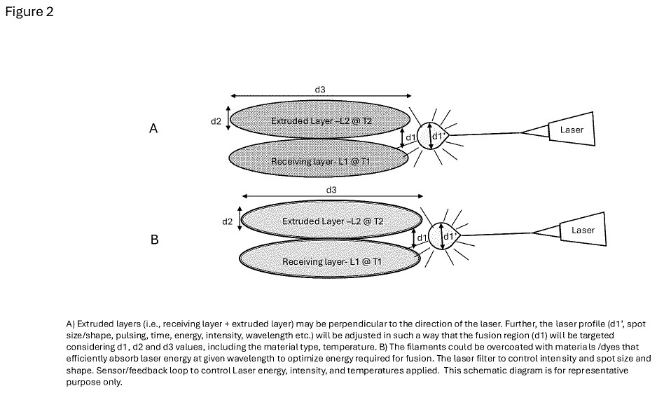

FIG. 2 illustrates the extruded and receiving layers in relation to a localized heat or laser configuration. The diagram shows how these layers are oriented perpendicular to the laser direction, with adjustable parameters such as spot size, pulsing, and intensity to optimize energy absorption. In FIG. 2, the extruded layers (i.e., receiving layer L1@T1 and the extruded layer L2@T2) may be perpendicular to the direction of the laser. Further, the laser profile (d1′, spot size/shape, pulsing, time, energy, intensity, wavelength etc.) can be adjusted in such a way that the fusion region (d1) will be targeted considering d1, d2 and d3 values, including the material type, temperature. The filaments could be formulated or overcoated with materials or dyes that efficiently absorb laser energy at the given wavelength to optimize energy required for fusion. The laser filter can control intensity and spot size and shape. Sensor(s) in a feedback loop is used to control Laser energy and intensity applied. Software controls the temperature. However, the localized heating system or laser could target layers L1 and L2 at any angle between 0 to 180 degrees to accomplish targeted structural properties.

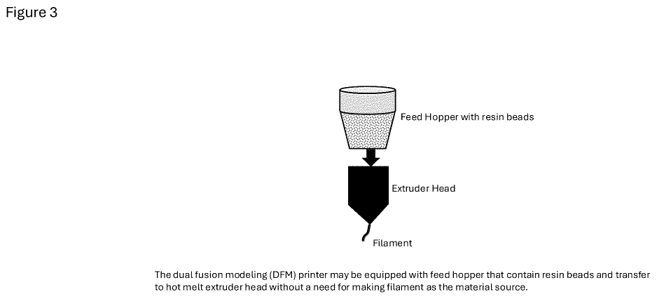

FIG. 3 illustrates a feed hopper containing resin beads connected to an extruder head, which produces filament. The DFM printer may be equipped with feed hopper that contain resin beads and transfer to hot melt extruder head without a need for making filament as the material source.

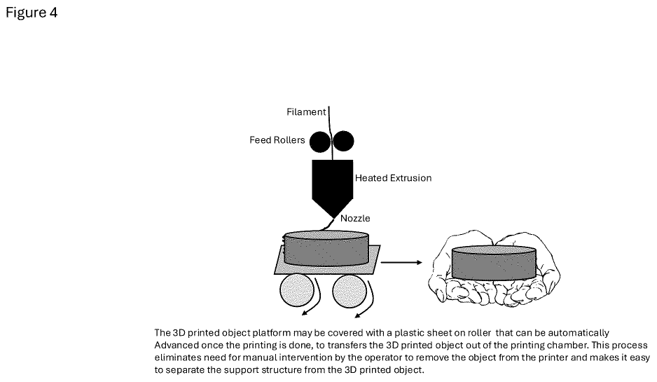

FIG. 4 illustrates the process of a nozzle and feed rollers extruding filament onto a platform. The labeled parts include the filament, feed rollers, heated extrusion, and nozzle. Additionally, it shows a mechanism for automatically transferring the printed object from the build platform, reducing manual intervention. The 3D printed object platform may be covered with a plastic sheet on roller that can be automatically advanced once the printing is done, to transfers the 3D printed object out of the printing chamber. This process eliminates the need for manual intervention by the operator to remove the object from the printer and makes it easy to separate the support structure from the 3D printed object. The automatic transfer of printed object out of the printing chamber could done using several other mechanical or automation methods, the afore mentioned method is one of several such methods to minimize or eliminate manual handling of printed 3D objects

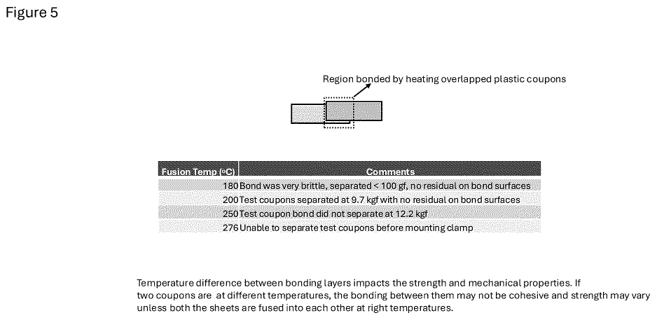

FIG. 5 shows a sample region bonded by heating overlapped plastic coupons. Temperature difference between bonding layers impacts the strength and mechanical properties. If two coupons are at different temperatures, the bonding between them may not be cohesive and strength may vary unless both the sheets are fused into each other at right temperatures, as illustrated below. This feature can be exploited to deliberately create temperature gradient to alter the strength between successive layers so that they can be either fused or separated from each other.

### Fusion Temp (degC) Comments

180 Bond was very brittle, separated <100 gf, no residual on bond surfaces
200 Test coupons separated at 9.7 kgf with no residual on bond surfaces
250 Test coupon bond did not separate at 12.2 kgf
276 Unable to separate test coupons before mounting clamp

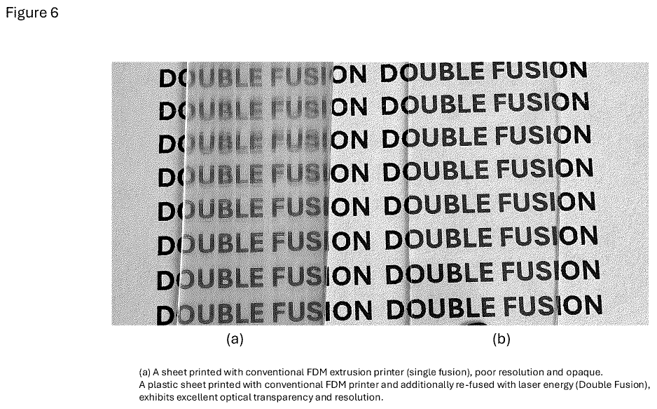

FIG. 6 shows an exemplary printed with conventional FDM extrusion printer (single fusion), poor resolution and opaque. A plastic sheet printed with conventional FDM printer and additionally re-fused with laser energy (Dual Fusion), exhibits excellent optical transparency and resolution. The optical clarity of printed objects and stain resistance of such objects play an extremely important role in applications that require light transmission (e.g., microfluidics) or aesthetic appeal (e.g., dental devices).

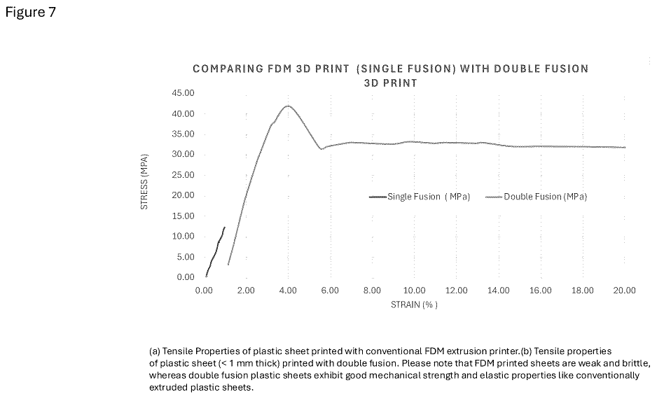

FIG. 7 shows an exemplary chart showing (a) Tensile Properties of plastic sheet printed with conventional FDM extrusion printer and. (b) Tensile properties of plastic sheet (<1 mm thick) printed with double fusion. Please note that FDM printed sheets are weak and brittle, whereas dual fusion of the same plastic sheets exhibit good mechanical strength and elastic properties like conventionally extruded plastic sheets. The data illustrates that FDM printed sheets tend to be weak and brittle, whereas double fusion plastic sheets demonstrate good mechanical strength and elastic properties similar to conventionally extruded plastic sheets as hypothesized earlier.

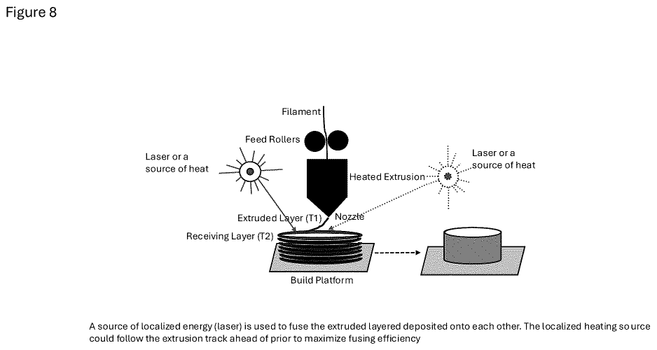

FIG. 8 illustrates a schematic of a 3D printing process using a laser for localized heating and extrusion. Filament is threaded through feed rollers and delivered to a nozzle that forms the extruded layer T1. A heat source or laser provides heat to the extruded layer T1 to form a receiving layer T2 on a build platform. A source of localized energy (laser) is used to fuse the extruded layered deposited onto each other. The localized heating source could be applied ahead of extrusion track or follow behind the extrusion track to maximize fusing efficiency at any angle ranging from 0 to 180 degrees depending upon the material type to be printed.

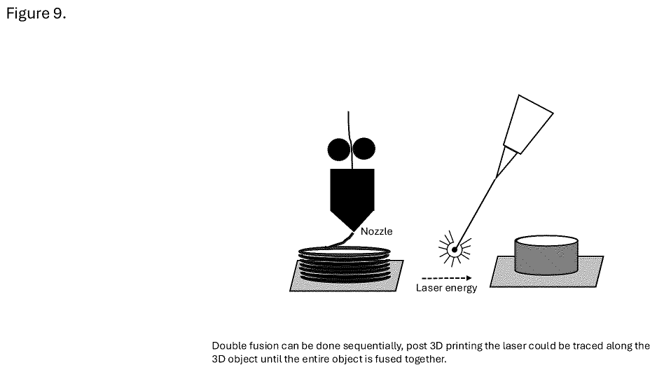

FIG. 9 illustrates a nozzle depositing material alongside a laser applying energy to a 3D printed object for fusion. Double fusion can be done sequentially, post 3D printing the laser could be traced along the 3D object until the entire object is fused together.

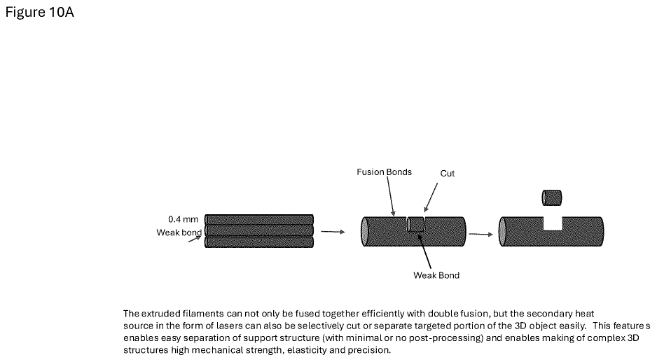

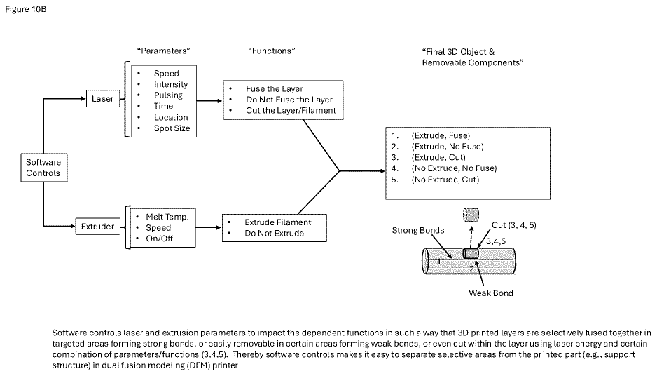

FIG. 10A illustrates cylindrical structures with identified strong and weak bonds, demonstrating a process of separation. The image depicts how extruded filaments can be effectively fused using double fusion in targeted areas to make them indistinguishable from each other. Additionally, it shows how lasers can selectively cut intra or inter layers to separate parts of a 3D object, facilitating easy removal of certain parts of support structures and enabling the creation of complex 3D forms with high mechanical strength, elasticity, and precision with least amount of post-processing work.

FIG. 10B shows software control of a laser and 3D printing extruder. The software controls localized heat or laser energy and extrusion parameters to impact the dependent functions in such a way that 3D printed layers are selectively fused together in targeted areas forming strong bonds, or easily removable in certain areas forming weak bonds, or even cut within the layer using laser energy and certain combination of parameters/functions (3,4,5). Thereby software controls makes it easy to separate selective areas from the printed part (e.g., support structure) in dual fusion modeling (DFM) printer. FIG. 10B depicts a diagram of a system where multiple layers is printed and selectively fused using a combination of extrusion and laser technology. The diagram shows several key components and processes:

Extrusion nozzle: responsible for depositing the material layer by layer. Parameters include melt temperature, speed, nozzle type, and on/off.

Localized heating system or laserLocalized heating or Laser: Positioned adjacent to the extrusion nozzle, it's used for selectively fusing or cutting the printed layers. Parameters include targeted temperature, speed, intensity, pulse width, pulse time, exposure duration, location, track of exposure, and spot size, among others. There could be more than one laser source, for example one laser could be used for fusion while the other could be used for cutting layers. The wavelength of the laser(s) could be anywhere from 250 nm to 2500 nm. While the localized heating system or laserlocalized heater can be a laser, it can be any system that generates heat. The localized heater could be conductive, inductive, radiative, and convective. For example, the Nanoworkbench from Klocke Nanotechnik performs spot heating of material and the heat source operates like a lamp: a tungsten wire is thinned at a tiny U-shaped front area down to about 30 microns and heats up the target, like the Tungsten spiral of a lamp.

In one implementation, the localized heating system or laser localized heater or laser assembly includes the extruder nozzle as one unit, and one rotation stage allow localized heating system or laser almost perpendicular towards the extruded element. The nozzle tip or opening can be circular, hexagonal, elliptical, square, or rectangular. In one implementation the shape is a track field like with 0.3 mm wide and 0.1 mm length. In one implementation the shape of nozzle is circular with 0.2 to 1.0 mm diameter. Similar to sealant dispense tip, this allows the extruder to more uniformly spread, resulting and much quicker and better build.

While the roller for the supply sheet can provision for building one set then roll and build another continuously, the system can use a magazine CD changer or similar design with a stack of plastic boards/sheets, once one is built, the system pushes and drops the sheet, and gets the next virgin sheet to be built upon.

The result is a product where multiple horizontal layers are shown, representing the build-up of the 3D printed object. The fusion zones are areas where the laser has been applied to create strong bonds between layers are indicated. The software controls include 1) fuse layer, 2) do not fuse the layer, and layer/filament cut, among others. Certain regions are depicted where the bond between layers is intentionally weaker, likely for support structures or parts meant to be removable. Cut zones are areas where the laser has been used to create cuts within a layer. The work flow for DFM may include:
a. 3D Model Creation: The process begins with creating a 3D model using Computer-Aided Design (CAD) software
b. Model Segmentation: The 3D model is segmented into thin layers using specialized slicing software.
c. G-code Generation: Instructions for each layer (G-code) are generated, incorporating both extrusion and laser control parameters.
d. DFM Printer: The G-code is transmitted to an advanced FDM printer equipped with a heated nozzle for melting and extruding thermoplastic filament and an integrated localized heating system (or laser): The printer deposits material layer by layer, with the laser system providing targeted energy related parameters for enhancing inter-layer fusion; creating controlled bond strengths (strong or weak) as needed; and Improving surface finish and optical properties
e. Removal of 3D printed part: The process allows for the creation of easily removable support structures through controlled weak bonding and intra layer cutting of material.
f. Multi-Material Printing: The system enables printing with multiple materials, expanding the range of achievable properties with modular DFM printing.
g. Continuous Monitoring: Real-time monitoring (e.g., using temperature sensors etc.) and adjustments, feedback loops ensure print quality and precision.

This enhanced process addresses key limitations of traditional 3D printing, offering improved mechanical strength, faster print speeds, smoother surfaces, potential for optical transparency, and simplified support removal. It leverages the cost-effectiveness and material versatility and quality unlike any of the existing 3D printers.

FIG. 10B demonstrates how the DFM printer can create a single object with varying bond strengths and even integrated cuts, allowing for complex structures with removable or separable components. The software control of both the extrusion and laser parameters enables this precise manipulation of the printing process, resulting in targeted areas of strong fusion, weak bonds, or cuts within the printed part.

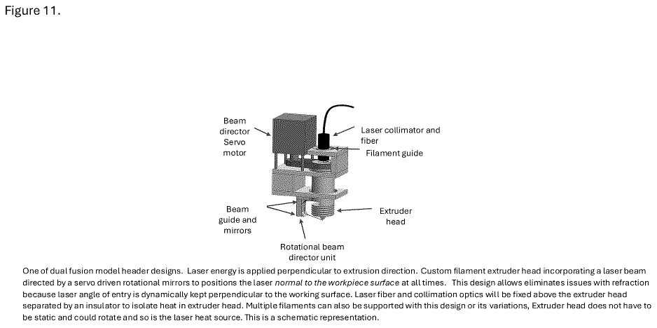

FIG. 11 illustrates another exemplary dual fusion model header design. Laser energy is applied perpendicular to extrusion direction. Custom filament extruder head incorporate a laser beam directed by a servo driven rotational mirrors to positions the laser normal to the workpiece surface at all times. This design eliminates issues with refraction because laser angle of entry is dynamically kept perpendicular to the working surface. Laser fiber and collimation optics will be fixed above the extruder head separated by an insulator to isolate heat in extruder head. Multiple filaments can also be supported with this design with a custom filament extruder head that applies laser energy perpendicular to the extrusion direction. The system uses a servo-driven rotational beam director unit, including components like a beam director, servo motor, laser collimator, fiber, and beam guide with mirrors. The extruder head and laser heat source can rotate, enhancing precision and accommodating multiple filaments.

A laser fiber and collimation optics are positioned near the extruder head. These components are separated from the extruder by an insulator, which serves to isolate the heat generated in the extruder head. A Dynamic Laser Positioning System is used, where the laser beam is directed by servo-driven rotational mirrors that allows the laser to be dynamically positioned normal (perpendicular) to the workpiece surface at all times. The perpendicular orientation eliminates issues with refraction that might occur with angled laser entry. The design supports the use of multiple filaments, enhancing its versatility for complex printing tasks. The extruder head is not necessarily static; it has the potential to rotate. The laser heat source can also rotate, providing additional flexibility in the printing process. Laser energy is applied perpendicular to the extrusion direction, which likely enhances the fusion process and potentially improves the quality of the printed object. The design combines traditional extrusion methods with advanced laser technology for potentially improved print quality and material fusion.

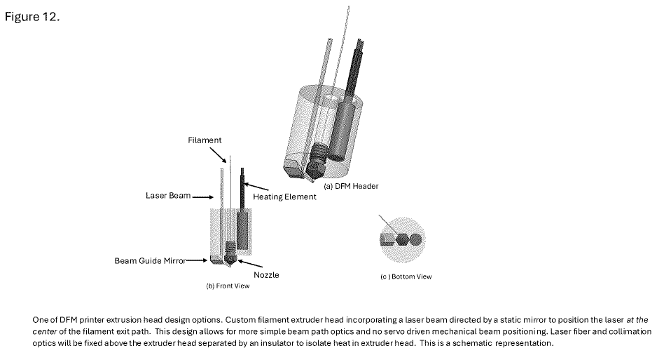

FIG. 12 illustrates the nozzle and filament assembly with a laser beam, heating element, and beam guide mirror in a 3D printer extrusion head design. A custom filament extruder head incorporating a laser beam directed by a static mirror to position the laser at the center of the filament exit path. This design allows for more simple beam path optics and no servo driven mechanical beam positioning. Laser fiber and collimation optics will be fixed above the extruder head separated by an insulator to isolate heat in extruder head. This design incorporates a laser beam system with a beam guide mirror adjacent the extrusion mechanism. A laser fiber and collimation optics are fixed above the extruder head. An insulator separates the laser components from the extruder head to isolate heat. A static mirror directs the laser beam to the center of the filament exit path. The filament enters through the top of the extruder head. A gear system is visible, likely for controlling filament feed rate. The extruder nozzle is positioned at the bottom, where the filament exits. Cooling fins may be attached the exterior of the extruder head for temperature management. The laser beam is positioned to interact with the filament at the point of extrusion. This design allows for simpler beam path optics without the need for servo-driven mechanical beam positioning. A similar design without the mirror can be used to accomplish additional simplicity, but could be used to fuse layers post-printing method (trailing) instead of getting the laser right where it is extruding. This method allows for a “top down” or perpendicular laser entry to the stacked layers for post fusing applications.

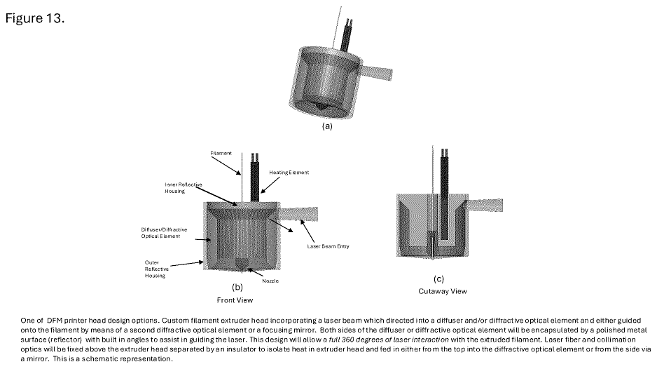

FIG. 13 shows another filament extruder head incorporating a laser beam which directed into a diffuser and/or diffractive optical element and either guided onto the filament by means of a second diffractive optical element or a focusing mirror. Both sides of the diffuser or diffractive optical element will be encapsulated by a polished metal surface (reflector) with built in angles to assist in guiding the laser. This design will allow a full 360 degrees of laser interaction with the extruded filament. Laser fiber and collimation optics will be fixed above the extruder head separated by an insulator to isolate heat in extruder head and fed in either from the top into the diffractive optical element or from the side via a mirror. The design depicts a custom filament extruder head design for a DFM printer that incorporates a laser beam to interact with the extruded filament. Here are the key components and features of this arrangement:

Laser Integration: The design incorporates a laser beam directed into a diffuser and/or diffractive optical element.

Beam Guidance: The laser beam is guided onto the filament using either a second diffractive optical element, or a focusing mirror.

Reflective Encapsulation: Both sides of the diffuser or diffractive optical element are encapsulated by a polished metal surface that acts as a reflector. This reflector has built-in angles to assist in guiding the laser.

360-Degree Interaction: This design allows for a full 360 degrees of laser interaction with the extruded filament, ensuring comprehensive coverage.

Laser Optics Placement: The laser fiber and collimation optics are fixed above the extruder head. They are separated from the extruder head by an insulator, which serves to isolate heat within the extruder head.

Laser Input Options: The laser can be fed into the system in two ways: from the top, directly into the diffractive optical element, or from the side, via a mirror.

This design aims to enhance the DFM printing process by incorporating laser technology to interact with the filament as it's being extruded, potentially offering improvements in filament properties or printing capabilities.

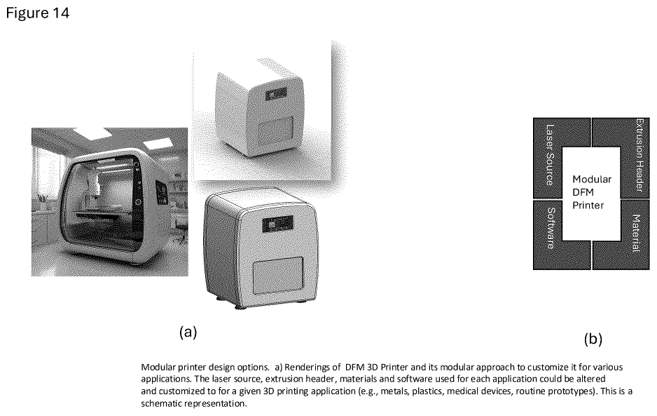

FIGS. 14A and 14B shows various modular printer design options. FIG. 14A shows renderings of DFM 3D Printer while FIG. 14B shows a modular approach to customize it for various applications. The DFM printer comprises four units: localized heating system (laser), software, materials, and extrusion system. The laser source, extrusion header, materials and software used for each application could be altered and customized to for a given 3D printing application (e.g., metals, plastics, medical devices, routine prototypes).

In one implementation, integrally associated with the extrusion system is a localized heating system or laser localized heating system or laser. This system is engineered to deliver localized heat to the freshly extruded layers. By doing so, it induces homogeneous polymeric fusion, improving the structural integrity of the printed object. This targeted heating allows the polymer chains to diffuse effectively between layers, thereby reducing potential weak bonds and enhancing the overall strength of the object. The localized heating system localized heating system or laser or laser functions in sync with the extrusion system, ensuring that both the receiving and extruded layers are in a compatible thermal state to facilitate optimal fusion. The control system, which governs both the extrusion and laser operations. The control system is embedded with advanced software algorithms that synchronize the speed and temperature profiles of the extrusion and laser mechanisms. By carefully regulating these parameters, the apparatus ensures the simultaneous solidification of the material, maintaining thermodynamic stability akin to conventionally extruded sheets. This coordination enables the printed material to exhibit superior mechanical, elastic, and optical characteristics, offering a solution to the limitations typically observed in conventional FDM printing. The control system also allows for adjustments based on material type, layer thickness, and part geometry. It provides flexibility in optimizing the laser region to accommodate variations in material properties, such as those involving composite filaments. Such composite filaments, comprised of metallic or ceramic particles, are held together with an organic binder that vaporizes under laser heat, enabling the metallic or ceramic components to fuse into a cohesive structure.

This dual fusion process not only enhances the surface resolution and transparency of the printed object but also addresses the critical aspect of producing metal and ceramic parts alongside polymer-based components on a single platform. The apparatus is thus capable of efficiently transitioning between different material states and printing modalities, achieving a seamless integration of diverse materials with precision. The design aligns with a modular approach, accommodating the varying requirements of diverse printing applications ranging from routine prototypes to sophisticated medical devices. Through this apparatus, the DFM technology sets a new standard in the realm of additive manufacturing, offering unparalleled advancements in print quality and material versatility.

The localized heating system or laser or laser in this one implementation is designed with advanced configurability to adjust various parameters, including intensity, spot size, wavelength, and energy, for optimal absorption and fusion of polymeric materials at specified wavelengths. This configuration enables precise control over the laser beam, ensuring that the energy delivered is sufficient to achieve effective fusion between layers, which is crucial in 3D printing applications. The system's ability to modulate laser intensity allows for adaptation to different polymeric compositions that may require varying levels of energy for successful fusion. Adjusting the spot size ensures that the laser can be fine-tuned to target specific areas, providing enhanced resolution and detail in the final printed object. The wavelength adjustment capability is key to optimizing energy absorption, as different polymeric materials may absorb energy more efficiently at particular wavelengths. By customizing the wavelength, the system enhances the energy efficiency of the process, reducing waste and improving overall printing speed. Energy modulation is essential for matching the energy requirements of various materials and thicknesses, ensuring consistent quality in the prints. This detailed configuration of the localized heating system or laser or laser is an integral part of one implementation, offering versatility and precision in 3D printing processes, thus addressing common limitations found in conventional methods and enabling the creation of high-quality objects with superior mechanical and optical properties.

The extrusion system of one implementation incorporates a feed hopper specifically designed for the direct introduction of resin beads into the system. This innovative feature eliminates the traditional requirement for pre-fabricated filament, streamlining the 3D printing process. By using resin beads, which are supplied directly to the extruder head, the system facilitates a continuous and efficient workflow. The feed hopper delivers the resin beads into a heated extrusion chamber where they are melted and subsequently extruded through the nozzle to form the desired 3D object layer by layer. This approach not only simplifies material handling but also reduces costs and material waste associated with filament production. The resin beads can be tailored for specific material properties, allowing for a versatile range of printing applications. The elimination of the filament pre-fabrication step enhances the system's adaptability and makes it highly suitable for various industrial, medical, and prototyping applications. The integration of this feed hopper into the extrusion system exemplifies a significant advancement in 3D printing technology, merging material efficiency with process innovation.

One implementation relates to an improved build platform equipped with an automated removal system designed for use in 3D printing. This system incorporates a plastic sheet arranged on rollers, which functions to facilitate the efficient separation and transport of printed objects from the build platform. The system operates by advancing the plastic sheet once the printing process is complete, allowing the printed object to be automatically transferred out of the printing chamber. This innovative approach eliminates the need for manual intervention by the operator in removing the object from the printer. Additionally, it simplifies the process of separating the support structure from the 3D printed object, thereby enhancing overall operational efficiency and reducing the time and effort required for post-processing procedures. The use of a roller mechanism ensures smooth and consistent movement of the plastic sheet, providing reliable conveyance of printed items regardless of their size or shape. This system is particularly advantageous in high-volume printing scenarios, where the speed of object removal can significantly impact productivity and throughput. The integration of this automated removal system into existing 3D printing platforms offers a robust solution for addressing common challenges in the post-printing phase, marking a substantial advancement in the field of additive manufacturing.

The control system of the dual fusion 3D printing technology incorporates a sophisticated sensor and feedback loop specifically designed to manage laser energy effectively, ensuring optimal conditions for the dual fusion process. This system plays a critical role in the precise modulation of laser intensity and spot size, enabling the fusion of layers to occur under controlled thermal conditions. By maintaining optimal temperatures, the feedback loop mitigates the risk of thermal inconsistencies, which can lead to defects in the final printed object. The integration of real-time monitoring allows for dynamic adjustments to be made during the printing process, thus improving the mechanical properties and overall quality of the 3D printed object. This advanced control system further enhances the versatility and reliability of the dual fusion method, setting it apart from traditional FDM techniques by promoting strong interlayer bonding and superior structural integrity.

One implementation provides a localized heating system or laser or laser configured to enhance the 3D printing process through precise targeting of specific regions within extruded layers. This system focuses on creating metal or ceramic 3D objects by effectively vaporizing polymer binders and subsequently fusing ceramic or metal particles. The laser operates in conjunction with a dual extrusion system that allows for the simultaneous deposition of composite filaments containing a mixture of metal or ceramic particles and organic binders onto a receiving layer. The localized heating system or laser or laser is calibrated to apply localized heat that exceeds the vaporization temperature of the binders, thus enabling the fusion of metallic or ceramic particles without impacting the structural integrity of the overall printed object. This targeted laser application ensures that the resulting 3D structure possesses not only defined mechanical properties but also enhanced resolution and detail that are unattainable with conventional 3D printing methods. The resultant composite material of the printed object displays improved mechanical strength and thermal resistance, making it applicable for various industrial and technological uses. The system further features adjustable laser intensity, wavelength, and focal size to accommodate different material compositions and desired structural outcomes. Sensors and feedback loops are integrated into the laser control system to maintain optimal energy application, ensuring precision in the creation of complex geometries and minimizing material waste. Through this innovative approach, one implementation significantly advances the capability of 3D printing technology in producing high-performance metal and ceramic objects with industrial relevance.

The extrusion system incorporates a configuration that creates a temperature gradient between the extruded layer and the receiving layer during the 3D printing process. This gradient is critical in determining the bonding strength between layers, which directly affects the structural integrity of the printed object. The receiving layer, which is already deposited onto the platform, maintains a cooler temperature relative to the newly extruded layer. As the extruded material is deposited, its higher temperature may not facilitate the diffusion of polymer chains into the receiving layer. This temperature differential causes that both layers are not unified upon cooling, on the other hand a more unified structure is accomplished if both extruded and receiving layer are at the temperature close to each other during cooling, preventing the formation of weak bonds that are commonly observed when there is temperature gradient. As a result, the 3D printed materials extruded under similar temperature conditions exhibit improved mechanical and elastic properties, as well as enhanced optical transparency. This method addresses limitations seen in traditional FDM processes by promoting a more homogeneous polymeric structure 2 and a robust bond across the layers 1. The precision in maintaining the temperature gradient is achieved through a combination of hardware control mechanisms and software algorithms that regulate the heating and cooling rates of both layers throughout the extrusion process. This precise control not only improves structural integrity but also reduces imperfections, enhances resolution, and optimizes the overall quality of the 3D printed object.

Moreover, the materials used in this process are selected for their biosafety, ensuring that the printed objects are safe for use in medical and consumer applications. The versatility of the materials allows the printer to work with a wide range of polymers, metals, and ceramics, adapting to various industrial and scientific needs.

DFM technology ensures that the polymeric chains within the printed layers form strong bonds, resulting in a uniform structure that contributes to the exceptional mechanical properties. The integration of a laser or other localized heat source during the printing process ensures that each layer is properly fused, maintaining consistency in temperature and phase, thus improving the structural integrity and transparency of the final product.

Through the modular design of the DFM printer, users can customize the extrusion head, laser source, and software settings to suit specific applications, from routine prototypes to complex medical devices to printing ceramic or metal objects. This adaptability, along with the enhanced material properties created by the dual fusion process, provides an advanced solution to the limitations of traditional FDM printing methods.

The extruded layers comprise a variety of products specifically designed to support complex applications such as microfluidics, medical devices, medical implants, containers, tubes, casts, dental tools, and surgical instruments. These products benefit from the unique properties imparted by the dual fusion modeling (DFM) technology, which enhances mechanical strength, resolution, and transparency. By incorporating advanced materials and precise construction methods, the DFM technology allows for the creation of microfluidic devices with intricate pathways and channels crucial for fluid control and manipulation in diagnostic and analytical applications. The robustness of the extruded layers makes them suitable for medical devices that require high precision and bio-compatibility, enabling the efficient fabrication of components that meet stringent regulatory standards. Containers and tubes fabricated using the extruded layers exhibit superior properties such as chemical resistance and mechanical integrity, making them ideal for storage and transport of sensitive materials. Casts produced through this method can be customized to fit anatomical specifications, providing enhanced support and ease of use in patient care. Dental and surgical tools benefit from the enhanced performance characteristics of the layers, which improve durability and usability in demanding clinical environments. The unique capabilities of the DFM technology in producing these diverse items demonstrate its versatility and potential to revolutionize product design and fabrication in these fields. By enabling the creation of complex geometries with high precision, the technology facilitates innovation in design and implementation, addressing both current needs and opening pathways to future developments in various high-demand sectors.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. An apparatus for 3D printing using Dual Fusion Modeling (DFM) technology, comprising:
an extrusion system configured to deposit successive layers of material onto a build platform;
a heating system configured to apply localized heating to the deposited layers for a pre-determined time period; and
a control system configured to coordinate the operation of the extrusion system and the heating system to form one or more 3D printed objects.

2. The apparatus of claim 1, wherein the control system is configured to coordinate the operation of the extrusion system and the heating system, wherein an intra or inter layer separation allows a 3D printed object to be fractionalized.

3. The apparatus of claim 1, further comprising a filament with a diameter ranging from 0.05 to 10.0 mm as a source of 3D printing material.

4. The apparatus of claim 1, wherein the heating system provides localized heating source and selected from convective, conductive, inductive, radiative heating method or combination thereof.

5. The apparatus of claim 1, wherein the heating system comprises a laser with wavelengths ranging from 200 nm to 2500 nm.

6. The apparatus of claim 1, wherein the localized heating area is configured to adjust at least one of the parameters such as temperature, intensity, size, shape, wavelength, pulsing time, and energy to optimize the fusion of polymeric materials.

7. The apparatus of claim 1, wherein the control system controls one or more extrusion parameters including melt temperature, speed of extrusion header, and extrusion on, and off functions; and controls one or more localized heating parameters including temperature, rate of heating, duration of heating, track of heating, heat intensity, wavelength, pulsing time, targeted region of heating.

8. The apparatus of claim 1, further comprising more than one localized thermal control system.

9. The apparatus of claim 1, wherein the control system selectively fuses or cuts inter and intra layers within a 3D printed object.

10. The apparatus of claim 1, wherein the printed 3D object comprises polymeric, ceramic, metallic or composite material or combinations thereof.

11. A method of 3D printing using Dual Fusion Modeling (DFM) technology, comprising:
extruding a filament comprising a polymeric material or a composite material;
depositing the extruded filament in a predetermined pattern;
simultaneously applying localized heat or laser energy to the deposited filament; and
controlling the extrusion and localized heating parameters to achieve homogeneous fusion of the deposited filament and separation of support structure.

12. (canceled)

13. A method of 3D printing a device, comprising:
selecting a biocompatible polymeric or composite filament;
extruding and depositing the filament in a predetermined pattern;
applying laser energy or laser parameters to fuse the deposited filament; and
controlling the laser energy or the laser parameters to maintain desirable biosafety and biomechanical properties.

14.-15. (canceled)

16. The method of claim 13, wherein the laser parameters include at least one of wavelength, intensity, power, spot size, duration and pulse rate.

17. The method of claim 13, further comprising utilizing a feedback loop or software controls to continuously monitor and adjust the laser energy or the laser parameters for optimal fusion conditions.

18. The method of claim 13, further comprising utilizing a feedback loop or software controls to continuously monitor and adjust the laser energy or the laser parameters for weakening inter and intra layer bonds for an easy separation of support structure from the 3D printed object.

19. The method of claim 1, wherein the one or more 3D printed objects are retainers, aligners, teeth whitening trays, mouthguards, dental implant guides, sleep apnea devices, and dental shells for drug delivery.

20. A method of 3D printing using Dual Fusion Modeling (DFM) technology, comprising:
extruding a filament comprising a polymeric material or a composite material;
depositing the extruded filament in a predetermined pattern to generate a 3D printed object;
applying laser energy to the 3D printed object in a predetermined pattern; and
optimizing the optical, and mechanical properties of the 3D printed object, and an ease of separation from the support structure.
